(19) United States
(12) Patent Application Publication
(10) Pub. No.: US 2003/0180641 A1
(43) Pub. Date: Sep. 25, 2003

(54) Toner for developing electrostatic latent image, process for producing the same, developer for developing electrostatic latent image, and process for producing image

(75) Inventors: Tomohito Nakajima, Minamiashigara-shi (JP); Satoshi Yoshida, Minamiashigara-shi (JP); Hidekazu Yaguchi, Minamiashigara-shi (JP); Takahisa Fujii, Minamiashigara-shi (JP); Yasuo Matsumura, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/219,498

(22) Filed: Aug. 16, 2002

(30) Foreign Application Priority Data
Feb. 14, 2002 (JP) 2002-036801

(51) Int. Cl. G03G 9/087

(52) U.S. Cl. 430/108.1; 430/109.3; 430/110.3; 430/110.4; 430/137.14; 430/111.4; 430/137.15; 430/137.17; 430/124

(57) ABSTRACT

A toner for developing an electrostatic latent image is provided that can prevent occurrence of blister even with coated paper having a coated surface, exhibits excellent releasing performance in oilless fixing, and realizes both high glossiness and OHP transparency for an image to be formed. A process for producing the toner, a developer containing the toner, and a process for forming an image using the toner are also provided. The toner for developing an electrostatic latent image contains a binder resin, a releasing agent and a colorant, in which the binder resin has a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin contains a vinyl resin.

### BACKGROUND OF THE INVENTION

1. Field of the Invention

The present invention relates to a toner for developing an electrostatic latent image used for developing, with a developer, an electrostatic latent image formed by an electrophotographic process or an electrostatic recording process, a process for producing a toner, a developer for developing an electrostatic latent image, and a process for forming an image.

2. Description of the Related Art

A process for visualizing image information through an electrostatic latent image by an electrophotographic process has been utilized in various fields of art. In the electrophotographic process, image information is formed as an electrostatic latent image on a surface of a photoreceptor by charging and exposing steps, and a toner image is developed on a surface of the electrostatic latent image by using a developer containing a toner. The image is then visualized through a transfer step, in which the toner image is transferred to an intermediate transfer material, and a fixing step, in which the toner image is fixed on a surface of a recording medium.

The developer used in the electrophotographic process includes a two-component developer containing a toner and a carrier and a one-component developer formed solely with a magnetic toner or a non-magnetic toner. The toner contained in the developer is generally produced by a kneading and pulverizing process, in which a thermoplastic resin is melted and kneaded with a pigment, a charge controlling agent and a releasing agent, such as wax, and after cooling, the mixture is finely pulverized and classified. In order to improve the flowability and the cleaning property of the toner thus produced, inorganic or organic fine particles may be added to the surface of the toner particles, depending on necessity.

In a color image formation by a full color electrophotographic process, which is quickly becoming popular in recent years, it is general that all the colors are reproduced by using four colors of toners, i.e., toners of three colors, yellow, magenta and cyan as three primary colors in the subtractive color process, and a black toner.

In the ordinary full color electrophotographic process, an original copy (image information) is subjected to color separation into yellow, magenta, cyan and black, and then electrostatic latent images for the respective colors are formed on a surface of a photoreceptor. The electrostatic latent images formed for the respective colors are then developed with developers containing toners of the respective colors to form toner images, and the toner images are then transferred to a surface of a recording medium through a transfer step. A series of the process steps from the formation of electrostatic latent images to the transfer of the toner images to the surface of the recording medium is sequentially carried out for the respective colors, whereby the toner images of the respective colors are transferred onto the surface of the same recording medium as they overlap each other to agree with the original image information. As a result, the full color toner image obtained by transferring the toner images of respective colors on the surface of the recording medium is formed into a full color image through a fixing step. The major difference between the full color electrophotographic process and the monochrome electrophotographic process is that several kinds of toners having different colors are accumulated on each other in the full color electrophotographic process.

It is necessary that color toners used in the full color electrophotographic process be sufficiently mixed with each other in the fixing step. This is because the color reproducibility and the transparency of an OHP image are improved by sufficient mixing, so as to obtain a full color image of high image quality. Accordingly, in comparison to a black toner used for forming a monochrome image, it is generally preferred that the color toner is formed with a low molecular weight resin, which has a low melting point and a narrow melting point range, i.e., has a sharp melt property, in order to improve the color mixing property.

In the conventional black toner for forming a monochrome image, wax having high crystallinity and a relatively high boiling point, such as polyethylene and polypropylene, is contained in order to prevent an offset phenomenon, in which, upon contacting a toner image in a heat-molten state with a fixing device, such as a heat roll, during the fixing step, a part of the toner image is transferred and attached to the surface of the heat roll. In the case of a toner having a high viscosity, such as a black toner for forming a monochrome image, it is general that a small amount of wax is oozed on the surface of the image due to the strong intermolecular cohesive force upon heat-melting of toner, whereby the offset phenomenon is prevented.

On the other hand, it is necessary that the heat melting property is increased by lowering the viscosity of toner in such cases that toners of two or more colors are accumulated to be colored as in the case of a full color toner, and a flat image surface is to be formed upon fixing to impart transparency to an OHP image. In order to prevent occurrence of the offset phenomenon in this case, it is necessary that a large amount of wax be incorporated in the full color toner.

However, in the case of the toner produced by the molten kneading and pulverization process, due to such a toner structure that the wax is exposed on the surface of the toner, it is liable that the large amount of wax exposed on the toner surface causes filming on a photoreceptor and causes pollution of the surfaces of the carrier and the developing sleeve, whereby the resulting image is liable to be deteriorated. Accordingly, the ordinary color toner for forming a full color image does not contain wax.

Therefore, in the case where an image is formed with such color toners, such a method is employed for preventing occurrence of the offset phenomenon that the surface of the heat roll is formed with silicone rubber or a fluorine resin that is excellent in releasing property to the color toners, and furthermore, a releasing liquid, such as a silicone oil, is supplied to the surface thereof.

This method is considerably effective for preventing the offset phenomenon, but a device for supplying the releasing liquid becomes necessary for preventing the offset phenomenon. This is contrary to the current tendency of an image forming apparatus of compact size and light weight, and the releasing liquid for preventing the offset phenomenon is liable to cause such problem that it is heated and evaporated to form offensive odor, and it is evaporated to pollute the interior of the image forming apparatus.

In order to solve the problems, such color toners have been developed for a color toner for forming a full color image that, in order to realize fixing operation without supplying a releasing liquid to the surface of the heat roll, a small amount of releasing agent containing, for example, wax having a low melting point is added to a low molecular weight resin having a sharp melt property.

In recent years, various kinds of demands for image formation upraise for home use, office use and on-demand printing, along with a demand for improving image quality and printing speed of duplicators and printers. In order to deal with the demands, recording media having various specifications, such as thickness, presence or absence of surface coating, and a surface treatment, are being used. Therefore, such a process for forming an image, particularly a fixing method, is being developed that can not only deal with the high image quality and the high printing speed, but also deal with the variety of the recording media.

In order to form an image of high image quality irrespective to the variety of the recording media, the following is important as the performance of the color toner contained in the developer. That is, in addition to the performance in the developing and transferring steps demanded for the conventional toners, it is important that, upon a fixing step for fixing a color toner image on the surface of the recording medium, the toner is uniformly fixed thereon without any unevenness irrespective to the surface state of the recording medium, such as presence or absence of a coating treatment, and the thickness of the recording medium.

In addition to introduction of new structures and optimization of image formation conditions in an image forming apparatus, there are such backgrounds in development of color toners that formation of a uniform transferred image to a surface of the recording medium and a stable transfer rate are attained by developing and employing a technique for producing a color toner having a narrow particle diameter distribution and a uniform particle size, whereby the performance of a color toner is considerably improved.

As an example of the method for improving the color toner as in the foregoing, the following production process has been proposed. That is, an oily phase having dissolved therein a monomer as a raw material of the resin and a colorant is dispersed in an aqueous phase to prepare a solution, and the solution is polymerized to form a toner, whereby the particle diameter distribution can be controlled to be narrow by the polymerization reaction without classification of the toner obtained by polymerization, which has been practiced in the conventional toners.

In addition to the foregoing, production processes of a toner by an emulsion polymerization aggregation process are proposed as a method for intentional control of the toner shape and the surface structure thereof in Japanese Patent Laid-Open No. 282752/1988 and Japanese Patent Laid-Open No. 250439/1994. In these processes, in general, a binder resin particle dispersion is prepared by emulsion polymerization, and separately, a colorant dispersion having a colorant dispersed in a solvent is prepared. These dispersions are mixed to form aggregated bodies having a diameter substantially corresponding to the toner particle diameter, and then they are coalesced by heating to produce a toner.

This production process of a toner is useful to easily control the particle diameter distribution into a narrow range, which is effective to obtain high transfer property, and furthermore is advantageous in controllability of the contained amount of the releasing agent encompassed by the toner and particularly in production of a toner having a smaller particle diameter, owing to the principal of formation of particles in this process, i.e., the aggregated bodies are formed from particles in the dispersions. In the case where image formation is carried out by using such a toner having a smaller diameter that is produced by these production processes, it is possible that not only an image of high definition and high quality is provided, but also a cost for forming an image per one sheet of a recording medium is reduced by suppressing the consuming amount of the toner.

Furthermore, in order to improve versatility of toners to a recording medium, various studies and developments have been carried out for an image forming apparatus, in addition to the studies for toners as described in the foregoing. That is, a tandem developing method, in which a recording medium can be transported without flexing it in an image forming apparatus, and employment of an intermediate transfer material, which can realize transfer irrespective to the thickness of the recording medium, have been proposed. However, even though any method is employed in the developing and transferring steps, such an image forming apparatus still prevails that contains a fixing device of a toner heating and melting type using a heat roll or a heat belt in the fixing step, and it is the current situation that no effective measure has been found for removing image defects upon fixing with respect to the latent heat added to the recording medium upon fixing and the surface treatment and modification of the recording medium.

The image defects upon fixing noted in the foregoing are often removed by controlling the physical property of the toner relating to the fixing process, and as examples of the method, such procedures have been often employed that a modifier is contained in the toner, and the composition of the binder resin, which is the main component of the toner, is changed.

However, as seen in the technique disclosed in Japanese Patent Laid-Open No. 198876/1987, it is difficult to control the image defects upon fixing with respect to the surface treatment and modification of the recording medium, particularly it is difficult to control the occurrence of image breakage due to bubbles that are liable to be formed upon fixing a toner image on a surface of coated paper with a heat roll (blister). Accordingly, there is no effective measure for preventing the occurrence of blister except for modification of the surface of the recording medium itself and employment of low temperature fixing.

### SUMMARY OF THE INVENTION

The invention has been developed for solving the foregoing problems associated with the conventional techniques. That is, the invention is to provide such a toner for developing an electrostatic latent image that can prevent occurrence of blister even with coated paper having a coated surface, exhibits excellent releasing performance in oilless fixing, and realizes both high glossiness and OHP transparency for an image to be formed. The invention also is to provide a process for producing the toner for developing an electrostatic latent image, a developer containing the toner for developing an electrostatic latent image, and a process for forming an image using the toner for developing an electrostatic latent image.

The toner for developing an electrostatic latent image contains a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

The process for producing a toner for developing an electrostatic latent image, the process containing a first step of aggregating particles in a dispersion containing binder resin particles, colorant particles and releasing agent particles, to obtain aggregated particles; and a second step of heating the aggregated particles to coalesce them, the toner containing a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

The developer for developing an electrostatic latent image of the invention contains the toner of the invention and a carrier.

The process for forming an image of the invention contains at least steps of: forming an electrostatic latent image on an electrostatic latent image holding member; developing the electrostatic latent image with a developer to form a toner image; transferring the toner image to a transfer material; and fixing with heat and pressure the toner image thus transferred to the transfer member to a recording medium, the developer being the developer for developing an electrostatic latent image of the invention.

### PREFERRED EMBODIMENTS OF THE INVENTION

The invention will be described by roughly classifying into, in this order, the mechanisms of formation of blister and studies of countermeasures therefor, the toner for developing an electrostatic latent image and the process for producing the toner for developing an electrostatic latent image, the developer for developing an electrostatic latent image, and the process for forming an image.

(Mechanisms of Formation of Blister and Studies of Countermeasures Thereof)

Upon developing the invention, the inventors have carried out the following studies for the formation mechanisms of the image breakage caused by the bubbling phenomenon upon fixing (blister) and the countermeasures thereof.

Because the blister is liable to occur particularly in a high humidity environment, it is expected that the blister is caused by such a mechanism that water mainly contained in the recording medium and the toner image transferred to the surface of the recording medium is evaporated by rapid heating upon fixing, and the evaporated water escapes by breaking the surface of the image upon applying pressure with a roll.

In particular, the blister is liable to occur in the case where the recording medium used for forming an image is coated paper, in comparison to the case where it is ordinary paper. It is expected that the reason of the phenomenon is as follows. When water contained the toner layer is evaporated, and air is expanded upon heating the toner image on fixing, the water vapor and the expanded air cannot escape to the side of the coated paper opposite to the surface having the formed image through the fiber layer due to the presence of the surface coating of the coated paper, and therefore they are expelled by breaking the fixed toner layer in a molten state. It is considered that the same mechanism can be applied to the formation of blister in an OHP sheet.

Therefore, it is expected that the blister is easily and necessarily caused in a recording medium having high shielding property of water and air, such as coated paper and an OHP sheet, and even in a water-containing recording medium having low shielding property of water and air, the water content of the recording medium is fluctuated by fluctuation of temperature and humidity, so as to cause some cases where the occurrence of blister is strongly dominated by the fluctuation of temperature and humidity.

Accordingly, in order to prevent the occurrence of blister irrespective to the recording medium used for forming an image in fixing by using a conventional fixing device, the inventors have considered that it is important that the contents of water and air of the unfixed toner image on the surface of the recording medium are controlled by employing an optimum image formation process, and the minute content of water in the toner used for forming an image is controlled, whereby the invention described below has been completed.

(Toner for Developing Electrostatic Latent Image and Process for Producing Toner)

The toner for developing an electrostatic latent image (hereinafter sometimes simply abbreviated as a “toner”) of the invention contains a binder resin, a releasing agent and a colorant, in which the binder resin has a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin contains a vinyl resin.

Therefore, the invention can provide such a toner for developing an electrostatic latent image that can prevent occurrence of blister even with coated paper having a coated surface, exhibits excellent releasing performance in oilless fixing, and realizes both high glossiness and OHP transparency for an image to be formed, and the invention can provide a process for producing the toner, a developer containing the toner, and a process for fixing an image using the toner.

The occurrence of blister, which cannot be solved by the conventional techniques, can be prevented by the invention, and the reasons therefor are considered as follows.

The binder resin contained in the toner of the invention has a uniform length of the molecular chains of the resin molecules constituting the binder resin and has a small content of resin molecules having a low molecular weight, owing to the narrow molecular weight distribution thereof, whereby the binder resin itself becomes more hydrophobic, and water is difficult to be adsorbed by the binder resin. Accordingly, the minute content of water contained in the toner can be further decreased.

Furthermore, because the toner is produced by using the binder resin having a narrow molecular weight distribution as a raw material, the resulting toner necessarily has a narrow particle diameter distribution. Therefore, in the case where a toner image is formed by using the toner, the toner particles are densely packed without gap in the toner image, whereby water and air are difficult to be incorporated in gaps among the toner particles.

Because of the foregoing factors, the occurrence of blister can be suppressed, which is caused by expansion of water and air contained in the toner particles and the toner image (in gaps among the toner particles) upon rapid heating of the toner image in the step of heating and pressing the toner image on the surface of the recording medium upon fixing.

Owing to the effect of preventing the occurrence of blister, an image having no defect can be formed on coated paper having high glossiness, on which blister has been liable to occur, and at the same time, such an advantages is obtained that difference in glossiness between the image part and the non-image part on the surface of the coated paper is small because of the high glossiness of the image, whereby an image having high reality as a developed photographic image can be obtained.

The production process of the toner of the invention containing a binder resin, a releasing agent and a colorant is not particularly limited, and it is preferred that the toner is produced by the following process.

The toner of the invention can be produced by a production process containing a first step of aggregating particles in a dispersion containing binder resin particles, colorant particles and releasing agent particles, to obtain aggregated particles (hereinafter referred to as an “aggregated particle forming step”); and a second step of heating the aggregated particles to coalesce them, (hereinafter referred to as a “coalescence step”).

The colorant and the releasing agent may be added either by dispersing them in the binder resin particles to be added to the toner, or by mixing a colorant dispersion and a releasing agent dispersion with the binder resin particle dispersion to be added upon forming the aggregated particles. It is preferred that a colorant dispersion and a releasing agent dispersion are mixed with the binder resin particle dispersion, so as to add them upon forming the aggregated particles, because the respective dispersions can be easily produced, and the species thereof are not limited.

When the number average molecular weight (Mn) of the binder resin is less than 9,000, the binder resin contains a large proportion of resin molecules having a low molecular weight, and thus the affinity of the resin molecules with water is increased. Thus, the binder resin is liable to contain water in the resin itself, whereby blister is liable to occur upon fixing.

Therefore, the total molecular weight is too low even when the molecular weight distribution (Mw/Mn) is narrow, whereby the viscosity of the binder resin upon melting by heat becomes extremely low. Accordingly, in the coalescence step, in which the aggregated particles are coalesced by heating to form toner particles upon producing the toner, the shape of the aggregated particles are easily changed, and the shape of the resulting toner particles is difficult to be controlled. Furthermore, when the toner particles having such nature are fixed, the toner to be fixed is attached on the surface of the heat roll to adhere it, whereby the offset phenomenon occurs.

When the number average molecular weight (Mn) of the binder resin exceeds 18,000, on the other hand, the binder resin becomes stiff due to the high molecular weight of the resin molecules constituting the binder resin, and at the same time, the shape of the toner particles, particularly those having a large diameter, is difficult to be controlled in the coalescence step upon production of the toner, whereby the shape of the toner particles becomes random. An image formed with the toner obtained by using such a binder resin is difficult to have smoothness on the surface of the image, and it is difficult to satisfy the OHP transparency and the glossiness of the image part.

Even in the case where the number average molecular weight (Mn) is in the foregoing range, when the molecular weight distribution represented by the ratio (Mw/Mn) of the weight average molecular weight (Mw) and the number average molecular weight (Mn) exceeds 2.5, an amount of a low molecular weight component and/or an amount of the high molecular weight component of the resin molecules constituting the binder resin is increased. In this case, the problems occurring in the case where the number average molecular weight (Mn) is less than 9,000 and/or the problems occurring in the case where the number average molecular weight (Mn) exceeds 18,000 are caused.

It is necessary that the binder resin used in the toner of the invention satisfies the number average molecular weight (Mn) and the molecular weight distribution (Mw/Mn) noted in the foregoing, and is formed with a vinyl resin.

A vinyl resin has a lower cohesive force than a polyester resin. Therefore, upon optimizing the viscoelastic behavior as a toner, a vinyl resin of a higher molecular weight range than a polyester resin is to be used as a binder resin. According thereto, the change in glossiness depending on the fixing temperature becomes modest to provide such an advantage that a stable gloss level can be maintained upon continuous image formation. Furthermore, a vinyl resin as the binder resin can be produced by an emulsion polymerization method in comparison to a polyester resin, and therefore, binder resin particles having a uniform submicron particle diameter can be easily obtained in comparison to a polyester resin. A toner containing a binder resin formed with such a vinyl resin having a narrow particle diameter distribution (i.e., a narrow molecular weight distribution) can exert both stable gloss characteristics and prevention of occurrence of blister and offset at the same time, and moreover, it is excellent in shape controllability thereof upon production of the toner.

The vinyl resin used as the binder resin in the invention means the following resin. Examples of the binder resin include a vinyl resin containing a resin formed by polymerizing a vinyl monomer solely and/or a resin formed by copolymerizing a vinyl monomer and a monomer other than vinyl monomers, and a resin formed by adding other resins or wax to the vinyl resin.

The content of the vinyl resin in the binder resin is not particularly limited, and it is preferably 50% by weight or more, and more preferably 70% by weight or more. In the case where the vinyl resin contains the resin formed by copolymerizing a vinyl monomer and a monomer other than vinyl monomers, the proportion of the vinyl monomer is preferably 50% by mole or more based on the total amount of all the monomers used for polymerization, and more preferably 80% by mole or more. It is most preferred in the invention that the binder resin contains only a resin formed by polymerizing only a vinyl monomer.

Specific examples of the binder resin include a homopolymer and a copolymer formed by polymerizing at least one kind of a monomer that necessarily contains a vinyl monomer selected from a styrene compound, such as styrene and parachlorostyrene, a vinyl ester, such as vinylnaphthalene, vinyl chloride, vinyl bromide, vinyl fluoride, vinyl acetate, vinyl propionate, vinyl benzoate and vinyl butyrate, a methylene aliphatic carboxylate ester, such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate, n-butyl methacrylate and isobutyl methacrylate, acrylonitrile, methacrylonitrile, acrylamide, a vinyl ether, such as vinyl methyl ether, vinyl ethyl ether and vinyl isobutyl ether, an N-vinyl compound, such as N-vinylpyrrol, N-vinylcarbazole, N-vinylindol and N-vinylpyrrolidone, and a vinylcarboxylic acid, such as methacrylic acid, acrylic acid and cinnamic acid. Furthermore, mixtures obtained by adding various kinds of polyester, polyethylene, polypropylene and various kinds of wax, such as paraffin, rice wax, candelilla wax and carnauba wax, to the foregoing homopolymer and/or the foregoing copolymer can also be used.

The production of the binder resin (binder resin particles) used in the toner of the invention may be carried out by using the known method, such as emulsion polymerization, by any method under any condition in that the conditions of the number average molecular weight (Mn) and the molecular weight distribution (Mw/Mn) of the invention are satisfied, and it is practically preferred that the binder resin is produced by the following method.

Such production process of the toner of the invention is preferred that the binder resin particles are produced by emulsion polymerization containing a step of polymerizing by supplying at least a monomer and a chain transfer agent to a reaction solution containing an initiator. It is preferred in this process that the monomer and the chain transfer agent are supplied in such a manner that a concentration of the chain transfer agent with respect to the monomer is maintained at a constant value or is decreased during supplying.

The term “supplying” herein means that all the monomer and the chain transfer agent used for the emulsion polymerization are supplied to the reaction solution in a continuous manner and/or an intermittent manner over a certain period, but it does not mean that all the monomer and the chain transfer agent are supplied at a time to the reaction solution.

Upon supplying the monomer and the chain transfer agent to the reaction solution, it is preferred that both of them are substantially simultaneously supplied. For example, in the case where the monomer and the chain transfer agent are alternately supplied with a certain interval, when the interval is too long, the number average molecular weight (Mn) and the molecular weight distribution (Mw/Mn) are changed in comparison to the case where both of them are simultaneously supplied, and thus there are some cases where they are difficult to be controlled. Therefore, even in the case where the monomer and the chain transfer agent are alternately supplied, it is preferred that they are supplied with an interval that can provide the number average molecular weight (Mn) and the molecular weight distribution (Mw/Mn) that are substantially equivalent to those obtained where they are simultaneously supplied.

The mode of the “supplying” may be any method as far as it is a method for supplying with continuity with respect to time. For example, the monomer and the chain transfer agent may be added dropwise to the reaction solution, or in alternative, they are directly dispatched into the reaction solution by using a pipe, such as a tube. Supplying paths upon supplying the monomer and the chain transfer agent to the reaction solution may be the same as each other or may be different from each other.

The term “concentration of the chain transfer agent with respect to the monomer” means a concentration of the chain transfer agent per a unit amount of the monomer (hereinafter abbreviated as a “chain transfer agent concentration”). In the case where the monomer and the chain transfer agent are alternately added with a certain interval, the chain transfer agent concentration can be determined based on the amounts of the monomer and the chain transfer agent that are supplied over a unit period of time. The “reaction solution” means a solution capable of enabling a polymerization reaction of the monomer by supplying the monomer to the reaction solution.

However, as the method for supplying the monomer and the chain transfer agent to the reaction solution, the so-called emulsion dropping method is practically preferred in that the monomer and the chain transfer agent are dissolved in an emulsion solution, and the emulsion solution is added dropwise to the reaction solution.

The emulsion solution may be added dropwise to the reaction solution in either a continuous manner or a non-continuous manner, and at least two kinds of emulsion solutions having different chain transfer agent concentrations may be added dropwise. At this time, the chain transfer agent concentration of the emulsion solution to be added dropwise to the reaction solution may be adjusted, for example, in the following manner.

In the case where one kind of an emulsion solution having a certain chain transfer agent concentration is used, the chain transfer agent concentration during dropping can be adjusted to maintain at a constant value. In the case where two or more kinds of emulsion solutions having different chain transfer agent concentrations are used, the emulsion solutions are added dropwise sequentially from an emulsion solution having a larger chain transfer agent concentration to an emulsion solution having a smaller chain transfer agent concentration, whereby the chain transfer agent concentration during dropping can be adjusted to decrease it. The later procedure is more preferred from the standpoint of controllability of the number average molecular weight (Mn) and the molecular weight distribution (Mw/Mn).

As described in the foregoing, the binder resin having the number average molecular weight (Mn) and the molecular weight distribution (Mw/Mn) that are necessary for constituting the toner of the invention can be easily obtained by adjusting the chain transfer agent concentration.

Examples of the chain transfer agent include those known in the art, e.g., a sulfur-containing compound, such as dodecanethiol, propanethiol and butanethiol, a carbon tetrabromide, and a halogen-containing compound, such as monochlorotribromocarbon. Examples of the initiator include those known in the art, e.g., a persulfate compound, such as potassium persulfate, sodium persulfate and ammonium persulfate, and a peroxide compound, such as diisopropylbenzene peroxide, cumene hydroperoxide and butyl hydroperoxide. In the emulsion solution and the reaction solution, other additives, such as an ionic surfactant, may be added depending on necessity.

As described in the foregoing, it is preferred that the binder resin used in the aggregated particle forming step is in a form of dispersed as particles in the solution, i.e., in the form of a binder resin particle dispersion. The same is also applied to the releasing agent and the colorant.

In this case, when the monomer used for polymerizing the binder resin particles is only a vinyl monomer, the reaction solution after completing the polymerization reaction can be used as it is as the binder resin particle dispersion. In the case where the binder resin particles are obtained by emulsion polymerization of a vinyl monomer and other monomers than a vinyl monomer, the binder resin particle dispersion can be obtained in the following manner. When the binder resin particles are soluble in a non-hydrophilic solvent that has a relatively low solubility in water, the binder resin particles are dissolved in the solvent, to which an ionic surfactant and polymer electrolyte are added, and the mixture are dispersed in water in a fine particle form by using a disperser, such as a homogenizer, followed by distilling off the solution by heating or under reduced pressure to obtain the binder resin particle dispersion.

The binder resin particles in the binder resin particle dispersion thus obtained preferably have a center diameter (median diameter) of 1 μm or less, more preferably in a range of from 50 to 400 nm, and further preferably in a range of from 70 to 350 nm. The center diameter of the binder resin particles can be measured with a laser diffraction particle size distribution measuring apparatus (LA-700, produced by Horiba, Ltd.).

As the colorant and the releasing agent used in the toner of the invention, known ones can be used. It is also possible in the toner of the invention that a magnetic material, such as a metal, an alloy and a compound containing a metal, such as ferrite, magnetite, reduced iron, cobalt, nickel and manganese, are used as an internal additive, and various kinds of charge controlling agents that have been ordinarily used, such as a quaternary ammonium salt compound, a nigrosine compound, a dye containing a complex of aluminum, iron or chromium, and a triphenylmethane pigment, are used as a charge controlling agent. Those materials that are difficult to be dissolved in water are preferred as them from the standpoint of control of the ion intensity, which influences the stability of the aggregated particles and the toner particles in the aggregated particle forming step and the coalescing step, and reduction of contamination due to waste water.

As the colorant used in the toner of the invention, various kinds of pigments and dyes are used, and specific examples thereof include the following.

Examples of a black pigment include carbon black, copper oxide, manganese dioxide, aniline black, activated carbon, non-magnetic ferrite and magnetite.

Examples of a yellow pigment include chrome yellow, zinc yellow, yellow iron oxide, cadmium yellow, chrome yellow, hansa yellow, hansa yellow 10G, benzidine yellow G, benzidine yellow GR, suren yellow, quinoline yellow and permanent yellow NCG.

Examples of an orange pigment include red chrome yellow, molybdenum orange, permanent orange GTR, pyrazolone orange, vulkan orange, benzidine orange G, indanthrene brilliant orange RK and indanthrene brilliant orange GK.

Examples of a red pigment include red iron oxide, cadmium red, red lead, mercury sulfide, watchyoung red, permanent red 4R, lithol red, brilliant carmine 3B, brilliant carmine 6B, Du Pont oil red, pyrazolone red, rhodamine B lake, lake red C, rose bengal, eosine red and alizarine lake.

Examples of a blue pigment include iron blue, cobalt blue, alkali blue lake, victoria blue lake, fast sky blue, indanthrene blue BC, aniline blue, ultramarine blue, calco oil blue, methylene blue chloride, phthalocyanine blue, phthalocyanine green and malachite green oxalate.

Examples of a violet pigment include manganese violet, fast violet B and methyl violet lake.

Examples of a green pigment include chromium oxide, chromium green, pigment green, malachite green lake and final yellow green G.

Examples of a white pigment include zinc flower, titanium oxide, antimony white and zinc sulfide.

Examples of a body pigment include barite powder, barium carbonate, clay, silica, white carbon, talc and alumina white.

Examples of a dye include various kinds of dye including basic, acidic, dispersed and direct dyes, for example, nigrosine, methylene blue, rose bengal, quinoline yellow and ultramarine blue.

These colorants are used solely or as a mixture. A dispersion of colorant particles can be prepared by using the colorant, for example, with a revolving shearing homogenizer, a media disperser, such as a ball mill, a sand mill and an attritor, or a high pressure counter collision type disperser. The colorant may be dispersed in an aqueous system with a homogenizer by using a surfactant having polarity.

The colorant used in the toner of the invention is selected in view of hue angle, chroma, brightness, weather resistance, OHP transparency and dispersibility in the toner. It is preferred in order to assure the coloring property upon fixing that the colorant is added in an amount in a range of from 4 to 15% by weight based on the total weight of the solid content of the toner, and more preferably in a range of from 4 to 10% by weight. In the case where a magnetic material is used as a black colorant, it is preferably added in an amount in a range of from 12 to 48% by weight, and more preferably in a range of from 15 to 40% by weight.

The colorant particles contained in the toner preferably have a center diameter (median diameter) in a range of from 100 to 330 nm, and more preferably in a range of from 100 to 200 nm. When the center diameter is in the range, the transparency and the coloring property can be assured where an image is formed on an OHP sheet. The center diameter of the colorant particles can be measured with a laser diffraction particle size distribution measuring apparatus (LA-700, produced by Horiba, Ltd.).

Preferred conditions for the releasing agent used in the toner of the invention will be described. The releasing agent preferably has a melting point in a range of from 70 to 120° C. and a melt viscosity at 150° C. in a range of from 1 to 150 centipoise, and the content of the releasing agent contained in the toner for developing an electrostatic latent image is preferably 10% by weight or more. The upper limit of the content of the releasing agent is not particularly limited, and it is practically preferably 25% by weight or less.

In the case where the melting point is lower than 70° C., there are some cases where the anti-blocking property becomes poor, and the developability is deteriorated when the inner temperature of the image forming apparatus is increased. In the case where the melting point exceeds 120° C., it is not preferred from the standpoint of energy saving, while the fixing can be carried out such a high temperature that corresponds to the melting point.

In the case where the melt viscosity of the releasing agent at 150° C. is less than 1 centipoise, the mount of the releasing agent that is eluted from the toner upon fixing is extremely large, whereby there are some cases where offset due to the releasing agent occurs, and image defects are liable to occur.

In the case where the melt viscosity of the releasing agent at 150° C. exceeds 150 centipoise, the releasing agent cannot be sufficiently melted upon fixing to reduce the amount of the releasing agent that is eluted from the toner, whereby there are some cases where the releasing property between the recording medium and the heat roll becomes insufficient.

In the case where the content of the releasing agent contained in the toner is less than 10% by weight, the amount of the releasing agent that is eluted from the toner upon fixing is short, whereby there are some cases where the releasing property between the recording medium and the heat roll becomes insufficient. This sometimes becomes conspicuous in a duplicator and a printer that are capable of outputting images at high speed and have an oilless fixing system. In the case where it exceeds 25% by weight, the amount of the releasing agent that oozes on the surface of the toner or that is liberated from the toner is increased, whereby there are some cases where problems are caused in the flowability and the storage stability of the toner itself.

The melting point of the releasing agent is more preferably in a range of from 70 to 105° C., the melt viscosity of the releasing agent at 150° C. is more preferably in a range of from 2 to 100 centipoise, and the content of the releasing agent contained in the toner for developing an electrostatic latent image is more preferably in a range of from 10 to 20% by weight.

In addition to the melting point, the melt viscosity at 150° C. and the content in the toner of the releasing agent, it is more preferred that the releasing agent satisfies the following conditions with respect to a major maximum endothermic peak obtained from a DSC curve measured according to ASTM D3418-8 by using a differential scanning calorimeter (hereinafter abbreviated as an “endothermic peak”) and an endothermic starting temperature obtained from the DSC curve.

The releasing agent preferably has an endothermic peak at a temperature in a range of from 50 to 140° C., and more preferably in a range of from 60 to 120° C. In the case where the endothermic peak is at a temperature lower than 50° C., there are some cases where an offset phenomenon is liable to occur upon fixing, and in the case where it is at a temperature exceeding 140° C., there are some case where the releasing agent is not sufficiently melted upon fixing, whereby the smoothness on the surface of the resulting image is reduced to impair the glossiness.

The endothermic starting temperature obtained from the DSC curve is preferably 40° C. or more, and more preferably 50° C. or more. In the case where the endothermic starting temperature is lower than 40° C., there are some cases where blocking of the toner occurs in the image forming apparatus or a toner bottle. The endothermic starting temperature herein means a temperature, at which the endothermic amount of the releasing agent starts to be changed with respect to increase of the temperature.

The endothermic starting temperature is determined by the relative proportion of molecules of a low molecular weight component among the molecules constituting the releasing agent, and the species and the number of polar groups contained in the structure of the molecules of the low molecular weight component. Therefore, in order to prevent the foregoing problems, it is necessary that the molecular weight of the molecules constituting the releasing agent is increased to increase the endothermic starting temperature as well as the melting point. However, when the molecular weight of the molecules of the releasing agent is increased, the melting property and the low viscosity at a low temperature, which are primarily required for the releasing agent, are impaired. Accordingly, it is preferred that only the low molecular weight component is selected and removed from the molecular weight distribution of the molecules constituting the releasing agent. Examples of the method for selective removal of the low molecular weight component include molecular distillation, solvent fractionation and gas chromatography.

The major maximum endothermic peak and the endothermic starting temperature can be measured with a differential scanning calorimeter, DSC-7 produced by Perkin-Elmer, Inc. The temperature compensation of the detecting element of the differential scanning calorimeter is carried out by using indium and zinc as the standard samples with the melting points thereof used as the standard. The compensation for the amount of heat is carried out by using indium as the standard sample with the heat of melting thereof used as the standard. The measurement is carried out in the following manner. Aluminum pans are used, and in such a state where the releasing agent is put on one pan, whereas the other pan is empty for reference, the temperature is increased from room temperature to about 200° C. at a temperature increasing rate of 10° C. per minute. The change in endothermic amount with respect to the temperature is obtained as a DSC curve.

Examples of the releasing agent used in the toner of the invention include a low molecular weight polyolefin, such as polyethylene, polypropylene and polybutene, a silicone exhibiting a softening point upon heating, an aliphatic amide, such as oleic amide, erucic amide, recinoleic amide and stearic amide, vegetable wax, such as carnauba wax, rice wax, candelilla wax, haze wax and jojoba oil, animal wax, such as yellow beeswax, mineral or petroleum wax, such as montan wax, ozokerite, ceresin, paraffin wax, microcrystalline wax and Fischer-Tropsch wax, and denatured materials thereof.

In the case where the releasing agent is the wax listed in the foregoing, the releasing agent dispersion, which is used in the aggregated particle forming step for preparing the aggregated particle dispersion, can be obtained in the following manner. The wax is dispersed in water along with an ionic surfactant and a polymer electrolyte, such as a polymer acid and a polymer base, and heated to a temperature higher than the melting point thereof, and it is dispersed into a fine particle form of a diameter of 1 μm or less with a homogenizer or a pressure discharge disperser (Gaulin Homogenizer, produced by Gaulin Corp.) capable of applying a strong shearing force. The particle diameter of the resulting releasing agent dispersion can be measured with a laser diffraction particle size distribution measuring apparatus (LA-700, produced by Horiba, Ltd.).

The toner of the invention is produced through the aggregated particle forming step, and in the aggregated particle forming step, it is preferred from the standpoint of securement of the charging property and the durability of toner that binder resin particles are further attached by using a binder resin particle dispersion to the surface of the aggregated particles (core particles) that are once obtained with the binder resin, the colorant and the releasing agent.

The toner of the invention may be formed as a magnetic toner by incorporating magnetic powder therein. The magnetic powder is not particularly limited as far as it is a substance that is magnetized in a magnetic field, and examples thereof include ferromagnetic powder, such as iron, cobalt and nickel, and a compound, such as ferrite and magnetite. In the case where water and/or a hydrophilic solvent is used upon producing the toner, it is preferred that the surface of the magnetic powder is modified, for example, by a hydrophobic treatment, so as to prevent the magnetic powder contained in the toner from being dissolved and/or eluted into the solvent.

As similar to the ordinary toners, in order to apply flowability and to improve the cleaning property, it is possible that the toner is dried, and then fine particles are added to the surface of the toner particles in a dry state under application of a sharing force. Examples of the fine particles include fine particles formed with an inorganic material, such as silica, alumina, titania and calcium carbonate, and fine particles formed with an organic material, such as a vinyl resin, polyester and silicone.

A surfactant can be used for emulsion polymerization of the binder resin particles, dispersion of the binder resin particles, dispersion of the pigment, dispersion of the releasing agent and stabilization of the aggregated particles in the aggregated particle dispersion obtained through the aggregated particle forming step, which are carried out for preparation of the binder resin particle dispersion, the releasing agent dispersion and the colorant dispersion used in the aggregated particle forming step. Specific examples of the surfactant include an anionic surfactant, such as sulfate ester series, sulfonate series, phosphate ester series and soap series, and a cationic surfactant, such as amine salt type and quaternary ammonium salt type. It is also effective to use a nonionic surfactant, such as polyethylene glycol series, alkylphenol ethylene oxide series and polyvalent alcohol series, in combination. As the dispersion method, those generally employed may be used, such as a revolving shearing homogenizer and a media disperser, such as a ball mill, a sand mill and a dynomill.

After completing the coalescence step for forming the toner particle by heating and coalescing the aggregated particles, the desired toner particles can be obtained through a washing step, a solid-liquid separating step and a drying step according to the known methods. In the washing step, it is preferred to carry out sufficient washing with ion exchanged water under consideration of charging property of the toner particles. While the solid-liquid separating step is not particularly limited and can be carried out by any known method, suction filtration and pressure filtration are preferred from the standpoint of productivity. The drying step is also not particularly limited and can be carried out by any known method, and freeze-drying, flash jet drying, flowing drying and vibration flowing drying are preferably employed from the standpoint of productivity.

The toner of the invention thus obtained preferably has an apparent weight average molecular weight in a range of from 15,000 to 55,000, and more preferably in a range of from 20,000 to 48,000. When the weight average molecular weight is less than 15,000, the cohesive force of the binder resin is liable to be lowered, and there are some cases where the releasing property upon oilless fixing is reduced. When the weight average molecular weight exceeds 55,000, there are some cases where the smoothness on the surface of the resulting image is reduced to impair the glossiness, while the releasing property upon oilless fixing is good.

The toner of the invention preferably has an apparent glass transition point Tg in a range of from 45 to 55° C., and more preferably in a range of from 48 to 53° C. When the glass transition point Tg is less than 45° C., the cohesive force of the binder resin itself at a high temperature range is lowered, and hot offset is liable to occur upon fixing. When the glass transition point Tg exceeds 55° C., there are some cases where the toner particles are not sufficiently melted upon fixing, whereby the glossiness of the resulting image is lowered.

The toner of the invention described in the foregoing preferably has the following shape and shape distribution.

The toner particles for developing an electrostatic latent image of the invention preferably have a shape factor SF1 in a range of from 100 to 140 and an average shape distribution index (S₈₄/S₁₆)^{1/2} of 1.08 or less. The shape factor SF1 is more preferably in a range of from 120 to 135, and the average shape distribution index (S₈₄/S₁₆)^{1/2} is more preferably 1.06 or less.

The shape factor SF1 and the average shape distribution index (S₈₄/S₁₆)^{1/2} are measured in the following manner by using a Luzex image analyzer (FT, produced by Nireco Corp.).

The shape factor SF1 is obtained in the following manner. An optical micrograph of the toner scattered on slide glass is imported to a Luzex image analyzer through a video camera, and the maximum length (ML) and the projected area (A) are measured for 500 or more toner particles. The shape factor SF1 is a value obtained therefrom by the equation (square of maximum length)/(projected area)×π/4×100=ML²/A×π/4×100. And an average value of the resulting values is obtained as the shape factor SF1. The shape factor SF1 is such a value that means that when the value approaches 100, the shape of the toner particle on the projected plane approaches the true sphere.

Furthermore, the measured range of the shape factor SF1 for all the toner particles measured by the Luzex image analyzer is designated from 100 to 172, and the measured range is divided into 24 segments, each of which has a segment width of 3. The number of the toner particles is counted for the respective segments and accumulated sequentially from the side of the segment of a smaller shape factor SF1. The value of the shape factor SF1, at which the accumulated number is 16%, is designated as S₁₆, and the value of the shape factor SF1, at which the accumulated number is 84%, is designated as S₈₄. The average shape distribution index (S₈₄/S₁₆)^{1/2} is obtained by using these values.

When the shape factor SF1 exceeds 140, the adhesive force of the toner to the photoreceptor and the intermediate transfer material is increased, and there are some cases where the transfer efficiency is deteriorated, and the resulting image becomes ununiform. When the average shape distribution index (S₈₄/S₁₆)^{1/2} exceeds 1.08, the distribution of the shapes of the toner particles is broadened, and there are some cases where the transfer efficiency from the photoreceptor and the intermediate transfer material to the recording medium becomes ununiform to cause unevenness in the resulting image.

In addition to the shape and the shape distribution defined by the projected area of the toner particles described in the foregoing, it is more preferred that the toner particles have the shape and the shape distribution defined by the volume of the toner particles described below.

The toner of the invention preferably has an accumulated volume average particle diameter D₅₀ᵥ in a range of from 3.0 to 9.0 μm, and more preferably in a range of from 3.0 to 8.0 μm. When D₅₀ᵥ is lower than 3.0 μm, there are some cases where the charging property of the toner is insufficient, and the developing property is lowered. When it exceeds 9.0 μm, there are some cases where the resolution property of the resulting image is lowered.

The toner of the invention preferably has a volume average particle size distribution index GSDv of 1.30 or less, and a ratio (GSDv/GSDp) of the value GSDv and the number average particle size distribution index GSDp of 0.95 or more. When GSDv exceeds 1.30, there are some cases where the resolution property of the resulting image is lowered, and when the ratio (GSDv/GSDp) is lower than 0.95, there are some cases where the charging property of the toner is lowered, which becomes a factor of image defects, such as scattering of the toner and fogging.

The accumulated volume average particle diameter D₅₀ᵥ and the volume average particle size distribution index GSDv can be calculated in the following manner. The particle size distribution is measured, for example, by a measuring apparatus, such as Coulter Counter TAII (produced by Nikkaki Co., Ltd.) and Multisizer II (produced by Nikkaki Co., Ltd.). Based on the particle size distribution, the values of volume and number for the divided particle size areas (channels) are obtained, and accumulated distributions thereof are drawn from the small particle size side. The particle diameters at the volume and the number of accumulation of 50% are defined as D₅₀ᵥ and D₅₀ₙ, respectively, the particle diameters at the volume and the number of accumulation of 16% are defined as D₁₆ᵥ and D₁₆ₙ, respectively, and the particle diameters at the volume and the number of accumulation of 84% are defined as D₈₄ᵥ and D₈₄ₙ, respectively. By using these values, the volume average particle size distribution index (GSDv) is calculated as (D₈₄ᵥ/D₁₆ᵥ)^{1/2}, and the number average particle size distribution index (GSDp) is calculated as (D₈₄ₙ/D₁₆ₙ)^{1/2}.

(Developer for Developing Electrostatic Latent Image)

The toner of the invention can be used as a developer by combining with a carrier. That is, the developer for an electrostatic latent image of the invention preferably contains the toner of the invention and a carrier.

As the carrier, the known carriers can be used without particular limitation, and examples thereof include an iron powder carrier, a ferrite carrier a surface coated ferrite carrier.

Any carrier having a spherical shape or an irregular shape can be used. The carrier preferably has a volume average particle diameter in a range of from 20 to 150 μm, and more preferably in a range of from 25 to 80 μm.

(Process for Forming Image)

In the case where image formation is carried out by using the developer for an electrostatic latent image of the invention, the process is preferably carried out in the following manner.

The process contains an electrostatic latent image forming step of forming an electrostatic latent image on an electrostatic latent image holding member; a developing step of developing the electrostatic latent image with a developer to form a toner image; a transferring step of transferring the toner image to a transfer material; and a fixing step of fixing with heat and pressure the toner image thus transferred to the transfer member to a recording medium, in which the developer is preferably the developer for developing an electrostatic latent image of the invention (hereinafter sometimes simply referred to as a “developer”).

Therefore, such a process for forming an image can be provided that can prevent occurrence of blister and can simultaneously realize both high glossiness and OHP transparency of the image thus formed.

In the case where image formation is carried out by the process for forming an image of the invention, the recording medium is preferably coated paper.

In this case, since the image formation is carried out by using the toner of the invention no blister occurs on coated paper, with which occurrence of blister has been difficult to be removed, and thus an image without image defect due to blister can be formed on the surface of coated paper.

In the case of the process for forming an image where the fixing step with heat and pressure is carried out by using a heat roll, it is preferred that the surface of the heat roll contains a fluorine resin, and the fixing step is oilless fixing.

Therefore, in addition to the effects described in the foregoing, such a process for forming an image can be provided that exerts excellent releasing performance in the oilless fixing, which is being employed in recent years as a fixing method for many image forming apparatuses, i.e., a method of fixing without any releasing liquid, such as a silicone oil, supplied to the surface of the heat roll.

The heat roll is not particularly limited as far as it has a surface (surface layer) containing a fluorine resin, and it may contain, in addition to a fluorine resin, other components, such as silicone rubber. From the standpoint of securement of the releasing property, it is preferred that the surface of the heat roll has surface energy that is suppressed to a low level, and therefore, it is preferred that the surface of the heat roll is uniformly coated with a fluorine resin. It is also preferred that an elastic layer is provided inside the surface layer.

In the fixing method using a heat roll, a recording medium having a toner image transferred to the surface thereof is inserted and passed through a pressure contact part (nip region) formed by contacting the heat roll and a pressure roll with each other under pressure. At this time, the toner image is heated and melted at the nip region and fixed on the surface of the recording medium, whereby a fixed toner image, i.e., an image, is formed.

At this time, the period of time t (msec) where the toner image is heated and pressurized is a value w/v obtained by dividing the width w (mm) of the nip region by the peripheral velocity v (mm/sec) of the roll. Therefore, when the width of the nip region is large, the period of time where heat is transmitted to the toner image is prolonged. In the case of toners for a full color image, it is necessary that the toners are transferred and accumulated on the recording medium to cause melt mixing, and thus sufficient heat is necessarily transmitted to the toners in comparison to the case of a toner for forming a monochrome image. Therefore, it is necessary that the nip width is increased for fixing the full color toners.

Because the toner of the invention exhibits a sufficient fixing latitude, substantially no releasing liquid, such as a silicone oil, to be coated on the surface of the heat roll is used. However, in the case where high speed printing is to be carried out, a slight amount of a releasing liquid may be supplied to assure the releasing property. For example, it is sufficient that the amount thereof is 1 μL or less per one sheet of a recording medium of the A4 size (210 mm×297 mm).

An image having a high glossiness can be obtained by the process for forming an image of the invention owing to the toner of the invention used for forming the image, and it is preferred for forming an image having a high glossiness that the image formation is carried out under the following conditions.

In the case where the fixing step is carried out by oilless fixing, it is preferred that the toner image is fixed with heat and pressure on the surface of the recording medium under such conditions that the recording medium used has a basis weight in a range of from 50 to 180 g/m², the toner image is formed on the surface of the recording medium to make a toner amount per unit area of 0.5 g/cm², the surface temperature of the heat roll is set in a range of from 150 to 190° C., and the peripheral velocity of the heat roll is set in a range of from 70 to 120 mm/sec. An image having a glossiness (gloss at 75°) of 60 or more can be formed by carrying out oilless fixing under the conditions. The image having such a high glossiness is suitable as a pictorial image and an OHP image, which are full color images of high image quality.

### EXAMPLES

The invention will be described in detail with reference to the following examples. However, the invention is not construed as being limited to the examples.

The production of the toner of the invention in the examples is carried out in the following manner. In the aggregated particle forming step, the binder resin particle dispersion, the colorant particle dispersion and the releasing agent particle dispersion shown below are separately prepared. They are then mixed and agitated at a prescribed proportions, and a metallic salt coagulating agent is added thereto to carry out ionic neutralization, whereby aggregated particles are formed.

In the coalescence step, which is carried out after the aggregated particle forming step, an inorganic hydroxide is added to adjust the pH of the system to a weakly acidic range to a neutral range, and then the system is heated to a temperature higher than the glass transition point of the binder resin to form a toner. Thereafter, the resulting toner is subjected to washing, solid-liquid separation and drying steps, and a developer is produced by using the toner. A test for forming an image and various kinds of evaluations for the toner are carried out.

The test for forming an image and the various kinds of evaluations for the toner and the standards therefor will be described later. The preparation of a binder resin particle dispersion, the preparation of a colorant particle dispersion, the preparation of a releasing agent particle dispersion, the production of a toner (Examples and Comparative Examples), the production of a developer, the test for forming an image, the various kinds of evaluations in the test for forming an image, the measurement of a molecular weight distribution of the toner, and evaluation results will be described below in this order.

(Preparation of Binder Resin Particle Dispersion)

(Binder Resin Particle Dispersion (1))

The components of the oily phase and the components of the aqueous phase 1 shown below are mixed and agitated in a flask (vessel 1) to form an emulsion solution. The component 5 of the aqueous phase 2 shown below are placed in another flask (vessel 2), and after sufficiently replacing the interior of the vessel 2 with nitrogen, the vessel 2 is heated over an oil bath until the temperature in the vessel 2 reaches 75° C. under agitation.

The emulsion solution in the vessel 1 is then gradually added dropwise to the vessel 2 over 3 hours to carry out emulsion polymerization. After completing the dropwise addition, the polymerization is further carried out for 3 hours at 75° C. in the vessel 2 to obtain a binder resin particle dispersion (1).

The resulting binder resin particles exhibit an accumulated number average particle diameter D₅₀ₙ of 350 nm as measured with a laser diffraction particle size distribution measuring apparatus (LA-700, produced by Horiba, Ltd.), a glass transition point of 54° C. as measured with a differential scanning calorimeter (DSC-50, produced by Shimadzu Corp.) at a temperature increasing rage of 10° C. per minute, a number average molecular weight (polystyrene standard) of 13,000 as measured with a molecular weight measuring apparatus (HLC-8020, produced by Tosoh Corp.) using THF (tetrahydrofuran) as a solvent, and a molecular weight distribution (Mw/Mn) of 2.2 as measured according to the molecular weight distribution measuring method described later.

(1) Oily phase

| | |
|---|---|
| Styrene | 30 parts by weight |
| (produced by Wako Pure Chemical Industries, Ltd.) | |
| n-Butyl acrylate | 10 parts by weight |
| (produced by Wako Pure Chemical Industries, Ltd.) | |
| β-carboxyethyl acrylate | 1.3 parts by weight |
| (produced by Rhodia, Inc.) | |
| Dodecanethiol | 0.4 part by weight |
| (produced by Wako Pure Chemical Industries, Ltd.) | |
| (2) Aqueous phase 1 | |
| Ion exchanged water | 17.5 parts by weight |
| Anionic surfactant | 0.35 part by weight |
| (DOWFAX 2A1, produced by Rhodia, Inc.) | |
| (3) Aqueous phase 2 | |
| Ion exchanged water | 40 parts by weight |
| Anionic surfactant | 0.05 part by weight |
| (DOWFAX 2A1, produced by Rhodia, Inc.) | |
| Ammonium persulfate | 0.4 part by weight |
| (produced by Wako Pure Chemical Industries, Ltd.) | |
| (Binder Resin Particle Dispersion (2)) | |

The components of the oily phase and the components of the aqueous phase 1 shown below are mixed and agitated in a flask (vessel 1) to form an emulsion solution. The components of the aqueous phase 2 shown below are placed in another flask (vessel 2), and after sufficiently replacing the interior of the vessel 2 with nitrogen, the vessel 2 is heated over an oil bath until the temperature in the vessel 2 reaches 75° C. under agitation.

The emulsion solution in the vessel 1 is then gradually added dropwise to the vessel 2 over 3 hours to carry out emulsion polymerization. After completing the dropwise addition, the polymerization is further carried out for 3 hours at 75° C. in the vessel 2 to obtain a binder resin particle dispersion (2).

The resulting binder resin particles exhibit an accumulated number average particle diameter D₅₀ₙ of 300 nm as measured with a laser diffraction particle size distribution measuring apparatus (LA-700, produced by Horiba, Ltd.), a glass transition point of 52° C. as measured with a differential scanning calorimeter (DSC-50, produced by Shimadzu Corp.) at a temperature increasing rage of 10° C. per minute, a number average molecular weight (polystyrene standard) of 11,000 as measured with a molecular weight measuring apparatus (HLC-8020, produced by Tosoh Corp.) using THF (tetrahydrofuran) as a solvent, and a molecular weight distribution (Mw/Mn) of 2.0 as measured according to the molecular weight distribution measuring method described later.

| | |
|---|---|
| (1) Oily phase | |
| Styrene | 30 parts by weight |
| (produced by Wako Pure Chemical Industries, Ltd.) | |
| n-Butyl acrylate | 10 parts by weight |
| (produced by Wako Pure Chemical Industries, Ltd.) | |
| β-carboxyethyl acrylate | 1.2 parts by weight |
| (produced by Rhodia, Inc.) | |
| Dodecanethiol | 0.6 part by weight |
| (produced by Wako Pure Chemical Industries, Ltd.) | |
| (2) Aqueous phase 1 | |
| Ion exchanged water | 17.5 parts by weight |
| Anionic surfactant | 0.35 part by weight |
| (Neogen RK, produced by Dai-ichi | |
| Kogyo Seiyaku Co., Ltd.) | |
| (3) Aqueous phase 2 | |
| Ion exchanged water | 40 parts by weight |
| Anionic surfactant | 0.05 part by weight |
| (Neogen RK, produced by Dai-ichi | |
| Kogyo Seiyaku Co., Ltd.) | |
| Ammonium persulfate | 0.3 part by weight |
| (produced by Wako Pure Chemical Industries, Ltd.) | |
| (Binder Resin Particle Dispersion (3)) | |

The components of the oily phase 1 and a half of the components of the aqueous phase 1 shown below are mixed and agitated in a flask (vessel 1) to form an emulsion solution 1, and similarly, the components of the oily phase 2 and the balance of the components of the aqueous phase 1 shown below are mixed and agitated in another flask (vessel 2) to form an emulsion solution 2.

The components of the aqueous phase 2 are placed in still another flask (vessel 3), and after sufficiently replacing the interior of the vessel 3 with nitrogen, the vessel 3 is heated over an oil bath until the temperature in the vessel 3 reaches 75° C. under agitation.

The emulsion solution 1 in the vessel 1 is then gradually added dropwise to the vessel 3 over 1.5 hours, and after completing the dropwise addition of the emulsion solution 1, the emulsion solution 2 in the vessel 2 is gradually added dropwise to the vessel 3 over 1.5 hours, to carry out emulsion polymerization. After completing the dropwise addition of the emulsion solution 2, the polymerization is further carried out for 3 hours at 75° C. in the vessel 3 to obtain a binder resin particle dispersion (3).

The resulting binder resin particles exhibit an accumulated number average particle diameter D₅₀ₙ of 280 nm as measured with a laser diffraction particle size distribution measuring apparatus (LA-700, produced by Horiba, Ltd.), a glass transition point of 53° C. as measured with a differential scanning calorimeter (DSC-50, produced by Shimadzu Corp.) at a temperature increasing rage of 10° C. per minute, a number average molecular weight (polystyrene standard) of 12,000 as measured with a molecular weight measuring apparatus (HLC-8020, produced by Tosoh Corp.) using THF (tetrahydrofuran) as a solvent, and a molecular weight distribution (Mw/Mn) of 1.9 as measured according to the molecular weight distribution measuring method described later.

| | |
|---|---|
| (1) Oily phase 1 | |
| Styrene | 15 parts by weight |
| (produced by Wako Pure Chemical Industries, Ltd.) | |
| n-Butyl acrylate | 5 parts by weight |
| (produced by Wako Pure Chemical Industries, Ltd.) | |
| β-carboxyethyl acrylate | 0.6 part by weight |
| (produced by Rhodia, Inc.) | |
| Dodecanethiol | 0.2 part by weight |
| (produced by Wako Pure Chemical Industries, Ltd.) | |
| (2) Oily phase 2 | |
| Styrene | 15 parts by weight |
| (produced by Wako Pure Chemical Industries, Ltd.) | |
| n-Butyl acrylate | 5 parts by weight |
| (produced by Wako Pure Chemical Industries, Ltd.) | |
| β-carboxyethyl acrylate | 0.6 part by weight |
| (produced by Rhodia, Inc.) | |
| Dodecanethiol | 0.1 part by weight |
| (produced by Wako Pure Chemical Industries, Ltd.) | |
| (3) Aqueous phase 1 | |
| Ion exchanged water | 17.5 parts by weight |
| Anionic surfactant | 0.35 part by weight |
| (DOWFAX 2A1, produced by Rhodia, Inc.) | |
| (4) Aqueous phase 2 | |
| Ion exchanged water | 40 parts by weight |
| Anionic surfactant | 0.05 part by weight |
| (DOWFAX 2A1, produced by Rhodia, Inc.) | |
| Ammonium persulfate | 0.3 part by weight |
| (produced by Wako Pure Chemical Industries, Ltd.) | |
| (Binder Resin Particle Dispersion (4)) | |

The components of the oily phase 1 and a half of the components of the aqueous phase 1 shown below are mixed and agitated in a flask (vessel 1) to form an emulsion solution 1, and similarly, the components of the oily phase 2 and the balance of the components of the aqueous phase 1 shown below are mixed and agitated in another flask (vessel 2) to form an emulsion solution 2.

The components of the aqueous phase 2 are placed in still another flask (vessel 3), and after sufficiently replacing the interior of the vessel 3 with nitrogen, the vessel 3 is heated over an oil bath until the temperature in the vessel 3 reaches 75° C. under agitation.

The emulsion solution 1 in the vessel 1 is then gradually added dropwise to the vessel 3 over 2 hours, and after completing the dropwise addition of the emulsion solution 1, the emulsion solution 2 in the vessel 2 is gradually added dropwise to the vessel 3 over 1 hour, to carry out emulsion polymerization. After completing the dropwise addition of the emulsion solution 2, the polymerization is further carried out for 3 hours at 75° C. in the vessel 3 to obtain a binder resin particle dispersion (4).

The resulting binder resin particles exhibit an accumulated number average particle diameter D₅₀ₙ of 290 nm as measured with a laser diffraction particle size distribution measuring apparatus (LA-700, produced by Horiba, Ltd.), a glass transition point of 51° C. as measured with a differential scanning calorimeter (DSC-50, produced by Shimadzu Corp.) at a temperature increasing rage of 10° C. per minute, a number average molecular weight (polystyrene standard) of 9,800 as measured with a molecular weight measuring apparatus (HLC-8020, produced by Tosoh Corp.) using THF (tetrahydrofuran) as a solvent, and a molecular weight distribution (Mw/Mn) of 3.0 as measured according to the molecular weight distribution measuring method described later.

| | |
|---|---|
| (1) Oily phase 1 | |
| Styrene | 15.3 parts by weight |
| (produced by Wako Pure Chemical Industries, Ltd.) | |
| n-Butyl acrylate | 0.46 part by weight |
| (produced by Wako Pure Chemical Industries, Ltd.) | |
| β-carboxyethyl acrylate | 0.6 part by weight |
| (produced by Rhodia, Inc.) | |
| Dodecanethiol | 0.2 part by weight |
| (produced by Wako Pure Chemical Industries, Ltd.) | |
| (2) Oily phase 2 | |
| Styrene | 15.3 parts by weight |
| (produced by Wako Pure Chemical Industries, Ltd.) | |
| n-Butyl acrylate | 0.46 part by weight |
| (produced by Wako Pure Chemical Industries, Ltd.) | |
| β-carboxyethyl acrylate | 0.6 part by weight |
| (produced by Rhodia, Inc.) | |
| Dodecanethiol | 0.4 part by weight |
| (produced by Wako Pure Chemical Industries, Ltd.) | |
| (3) Aqueous phase 1 | |
| Ion exchanged water | 17.5 parts by weight |
| Anionic surfactant | 0.35 part by weight |
| (Neogen RK, produced by Dai-ichi | |
| Kogyo Seiyaku Co., Ltd.) | |
| (4) Aqueous phase 2 | |
| Ion exchanged water | 40 parts by weight |
| Anionic surfactant | 0.05 part by weight |
| (Neogen RK, produced by Dai-ichi | |
| Kogyo Seiyaku Co., Ltd.) | |
| Ammonium persulfate | 0.3 part by weight |
| (produced by Wako Pure Chemical Industries, Ltd.) | |
| (Binder Resin Particle Dispersion (5)) | |

After mixing the components of the oily phase shown below, they are placed in a flask along with the components of the aqueous phase shown below, which are dispersed and emulsified. 4.4 parts by weight of ion exchanged water containing 0.4 part by weight of ammonium sulfate dissolved therein is added thereto over 10 minutes under slowly agitating and mixing. Thereafter, after sufficiently replacing the interior of the flask with nitrogen, the flask is heated over an oil bath until the temperature in the flask reaches 70° C. under agitation, and then emulsion polymerization is carried out for 5 hours, to obtain a binder resin particle dispersion (5).

The resulting binder resin particles exhibit an accumulated number average particle diameter D₅₀ₙ of 350 nm as measured with a laser diffraction particle size distribution measuring apparatus (LA-700, produced by Horiba, Ltd.), a glass transition point of 47° C. as measured with a differential scanning calorimeter (DSC-50, produced by Shimadzu Corp.) at a temperature increasing rage of 10° C. per minute, a number average molecular weight (polystyrene standard) of 7,500 as measured with a molecular weight measuring apparatus (HLC-8020, produced by Tosoh Corp.) using THF (tetrahydrofuran) as a solvent, and a molecular weight distribution (Mw/Mn) of 5.3 as measured according to the molecular weight distribution measuring method described later.

| | |
|---|---|
| (1) Oily phase | |
| Styrene | 35.3 parts by weight |
| (produced by Wako Pure Chemical Industries, Ltd.) | |
| n-Butyl acrylate | 2.8 parts by weight |
| (produced by Wako Pure Chemical Industries, Ltd.) | |
| Acrylic acid | 0.6 part by weight |
| (produced by Wako Pure Chemical Industries, Ltd.) | |
| Dodecanethiol | 2.3 parts by weight |
| (produced by Wako Pure Chemical Industries, Ltd.) | |
| Carbon tetrabromide | 0.4 part by weight |
| (produced by Wako Pure Chemical Industries, Ltd.) | |
| (2) Aqueous phase | |
| Ion exchanged water | 52.7 parts by weight |
| Nonionic surfactant | 0.6 part by weight |
| (Nonipole 400, produced by Sanyo | |
| Chemical Industries, Ltd.) | |
| Anionic surfactant | 0.9 part by weight |
| (Neogen R, produced by Dai-ichi | |
| Kogyo Seiyaku Co., Ltd.) | |
| (Preparation of Colorant Dispersion) | |
| (Colorant Dispersion (1)) | |

The following components are dispersed and mixed in a homogenizer (Ultra-Turrax T50, produced by IKA Works, Inc.) for 10 minutes to obtain a black colorant dispersion (1) having an accumulated number average particle diameter D₅₀ₙ of 250 nm.

| | |
|---|---|
| Carbon black | 20 parts by weight |
| (Mogal L, produced by Cabot, Inc.) | |
| Anionic surfactant | 2 parts by weight |
| (Neogen R, produced by Dai-ichi | |
| Kogyo Seiyaku Co., Ltd.) | |
| Ion exchanged water | 78 parts by weight |
| (Colorant Dispersion (2)) | |

The following components are dispersed and mixed in a homogenizer (Ultra-Turrax T50, produced by IKA Works, Inc.) for 10 minutes, and then dispersed with an ultrasonic irradiator (RUS-600, produced by Nippon Seiki Seisakusho Co., Ltd.) to obtain a blue colorant dispersion (2) having an accumulated number average particle diameter D₅₀ₙ of 150 nm.

| | |
|---|---|
| Phthalocyanine pigment | 20 parts by weight |
| (PB FAST BLUE 9, produced by BASF, Ltd.) | |
| Anionic surfactant | 2 parts by weight |
| (Neogen R, produced by Dai-ichi | |
| Kogyo Seiyaku Co., Ltd.) | |
| Ion exchanged water | 78 parts by weight |
| (Preparation of Releasing Agent Dispersion) | |
| (Releasing Agent Dispersion (1)) | |

The following components are sufficiently mixed and dispersed with a homogenizer (Ultra-Turrax T50, produced by IKA Works, Inc.) under heating to 95° C., and then subjected to a dispersion treatment with a pressure discharge homogenizer (Gaulin Homogenizer, produced by Gaulin Corp.), so as to prepare a releasing agent dispersion (1) having an accumulated number average particle diameter D₅₀ₙ of the releasing agent particles of 300 nm, a melting point thereof at 85° C. and a melt viscosity thereof at 150° C. of 10 centipoise.

| | |
|---|---|
| Paraffin wax | 30 parts by weight |
| (melting point: 85° C.) | |
| (HNP0190, produced by Nippon Seiro Co., Ltd.) | |
| Cationic surfactant | 3 parts by weight |
| (Sanisol B50, produced by Kao Corp.) | |
| Ion exchanged water | 67 parts by weight |
| (Releasing Agent Dispersion (2)) | |

The following components are sufficiently mixed and dispersed with a homogenizer (Ultra-Turrax T50, produced by IKA Works, Inc.) under heating to 95° C., and then subjected to a dispersion treatment with a pressure discharge homogenizer (Gaulin Homogenizer, produced by Gaulin Corp.), so as to prepare a releasing agent dispersion (2) having an accumulated number average particle diameter D₅₀ₙ of the releasing agent particles of 310 nm, a melting point thereof at 100° C. and a melt viscosity thereof at 150° C. of 12 centipoise.

| | |
|---|---|
| Polyethylene wax | 30 parts by weight |
| (melting point: 103° C.) | |
| (Polywax 725, produced by Toyo Petrolite, Co., | |
| Ltd.) | |
| Cationic surfactant | 3 parts by weight |
| (Sanisol B50, produced by Kao Corp.) | |
| Ion exchanged water | 67 parts by weight |
| (Production of Toner) | |

### Example 1

The following components are placed in a round-bottom stainless steel flask and sufficiently mixed and dispersed with a homogenizer (Ultra-Turrax T50, produced by IKA Works, Inc.). Thereafter, the contents of the flask are heated on a heating oil bath to 48° C. under agitation, and after maintaining the temperature for 30 minutes, the temperature of the heating oil bath is increased to 50° C., followed by maintaining the temperature for 1 hour, so as to obtain aggregated particles. Subsequently, 25 parts by weight of the binder resin particle dispersion (1) for coating the surface of the aggregated particles thus obtained are further added thereto and gradually agitated.

| | |
|---|---|
| Binder resin particle dispersion (1) | 54.8 parts by weight |
| Colorant dispersion (1) | 8 parts by weight |
| Releasing agent dispersion (2) | 12 parts by weight |
| Polyaluminum chloride | 0.2 part by weight |
| (PAC100W, produced by Asada Chemical Co., | |
| Ltd.) | |

Thereafter, the pH inside the flask is adjusted to a neutral region with a 0.5 M/L sodium hydroxide aqueous solution, and the contents are heated to 95° C. with maintained agitation, followed by maintaining at that temperature for 5 hours to be heated and coalesced, whereby a toner is formed. After completing the operation, the contents of the flask are cooled and sufficiently washed with ion exchanged water, followed by subjecting to solid-liquid separation by Nutsche suction filtration. The solid content is subjected to a washing operation by again dispersing in 3 L of ion exchanged water at 40° C., and then being washed by stirring for 15 minutes. The washing operation is repeated four times, and the solid content is subjected to solid-liquid separation by Nutsche suction filtration, followed by vacuum drying for 12 hours, to obtain a toner of Example 1.

The resulting toner particles have an accumulated number average particle diameter D₅₀ₙ of 5.9 μm and a number average particle size distribution index GSDn of 1.21, as measured with Coulter counter (TAII, produced by Nikkaki Co., Ltd.). The toner particles are measured for a water content, and it is 0.29%. It is confirmed by observation of the surface state of the toner particles with an electron microscope that the binder resin particles are fused on the surface of the core particles formed with the binder resin, the colorant and the releasing agent, to form a continuous layer. Upon observing the cross section of the toner with a transmission electron microscope, the releasing agent that oozes on the surface layer of the toner is substantially not found. The shape factor SF1 of the toner particles measured with a Luzex image analyzer is 129, and the average shape distribution index (S₈₄/S₁₆)^{1/2} is 1.074.

### Example 2

The following components are subjected to the same operation as in Example 1 to obtain aggregated particles. Subsequently, 25 parts by weight of the binder resin particle dispersion (2) for coating the surface of the aggregated particles thus obtained are further added thereto and gradually agitated. Thereafter, it is subjected to the same operation as in Example 1 to obtain a toner of Example 2.

| | |
|---|---|
| Binder resin particle dispersion (2) | 59.8 parts by weight |
| Colorant dispersion (1) | 8 parts by weight |
| Releasing agent dispersion (1) | 7 parts by weight |
| Polyaluminum chloride | 0.2 part by weight |
| (PAC100W, produced by Asada Chemical Co., | |
| Ltd.) | |

The resulting toner particles have an accumulated number average particle diameter D₅₀ₙ of 5.2 μm and a number average particle size distribution index GSDn of 1.22, as measured with Coulter counter (TAII, produced by Nikkaki Co., Ltd.). The toner particles are measured for a water content, and it is 0.31%. It is confirmed by observation of the surface state of the toner particles with an electron microscope that the binder resin particles are fused on the surface of the core particles formed with the binder resin, the colorant and the releasing agent, to form a continuous layer. Upon observing the cross section of the toner with a transmission electron microscope, the releasing agent that oozes on the surface layer of the toner is substantially not found. The shape factor SF1 of the toner particles measured with a Luzex image analyzer is 131, and the average shape distribution index (S₈₄/S₁₆)^{1/2} is 1.073.

### Example 3

The following components are subjected to the same operation as in Example 1 to obtain aggregated particles. Subsequently, 25 parts by weight of the binder resin particle dispersion (3) for coating the surface of the aggregated particles thus obtained are further added thereto and gradually agitated. Thereafter, it is subjected to the same operation again as in Example 1 to obtain a toner of Example 3.

| | |
|---|---|
| Binder resin particle dispersion (3) | 51.8 parts by weight |
| Colorant dispersion (1) | 8 parts by weight |
| Releasing agent dispersion (1) | 15 parts by weight |
| Polyaluminum chloride | 0.2 part by weight |
| (PAC100W, produced by Asada Chemical Co., | |
| Ltd.) | |

The resulting toner particles have an accumulated number average particle diameter D₅₀ₙ of 5.2 μm and a number average particle size distribution index GSDn of 1.23, as measured with Coulter counter (TAII, produced by Nikkaki Co., Ltd.). The toner particles are measured for a water content, and it is 0.25%. It is confirmed by observation of the surface state of the toner particles with an electron microscope that the binder resin particles are fused on the surface of the core particles formed with the binder resin, the colorant and the releasing agent, to form a continuous layer. Upon observing the cross section of the toner with a transmission electron microscope, the releasing agent that oozes on the surface layer of the toner is substantially not found. The shape factor SF1 of the toner particles measured with a Luzex image analyzer is 132, and the average shape distribution index (S₈₄/S₁₆)^{1/2} is 1.076.

### Example 4

The following components are subjected to the same operation as in Example 1 to obtain aggregated particles. Subsequently, 25 parts by weight of the binder resin particle dispersion (4) for coating the surface of the aggregated particles thus obtained are further added thereto and gradually agitated. Thereafter, it is subjected to the same operation again as in Example 1 to obtain a toner of Example 4.

| | |
|---|---|
| Binder resin particle dispersion (4) | 55 parts by weight |
| Colorant dispersion (1) | 8 parts by weight |
| Releasing agent dispersion (2) | 12 parts by weight |
| Polyaluminum chloride | 0.2 part by weight |
| (PAC100W, produced by Asada Chemical Co., | |
| Ltd.) | |

The resulting toner particles have an accumulated number average particle diameter D₅₀ₙ of 5.1 μm and a number average particle size distribution index GSDn of 1.22, as measured with Coulter counter (TAII, produced by Nikkaki Co., Ltd.). The toner particles are measured for a water content, and it is 0.30%. It is confirmed by observation of the surface state of the toner particles with an electron microscope that the binder resin particles are fused on the surface of the core particles formed with the binder resin, the colorant and the releasing agent, to form a continuous layer. Upon observing the cross section of the toner with a transmission electron microscope, the releasing agent that oozes on the surface layer of the toner is substantially not found. The shape factor SF1 of the toner particles measured with a Luzex image analyzer is 126, and the average shape distribution index (S₈₄/S₁₆)^{1/2} is 1.071.

### Comparative Example 1

The following components are placed in a round-bottom stainless steel flask and sufficiently mixed and dispersed with a homogenizer (Ultra-Turrax T50, produced by IKA Works, Inc.). Thereafter, the contents of the flask are heated on a heating oil bath to 48° C. under agitation, and after maintaining the temperature for 30 minutes, the temperature of the heating oil bath is increased to 50° C., followed by maintaining the temperature for 1 hour, so as to obtain aggregated particles. Subsequently, 25 parts by weight of the binder resin particle dispersion (4) for coating the surface of the aggregated particles thus obtained are further added thereto and gradually agitated.

| | |
|---|---|
| Binder resin particle dispersion (4) | 59.8 parts by weight |
| Colorant dispersion (1) | 8 parts by weight |
| Releasing agent dispersion (1) | 7 parts by weight |
| Polyaluminum chloride | 0.2 part by weight |
| (PAC100W, produced by Asada Chemical Co., | |
| Ltd.) | |

Thereafter, the pH inside the flask is adjusted to a neutral region with a 0.5 M/L sodium hydroxide aqueous solution, and the contents are heated to 95° C. with maintained agitation, followed by maintaining at that temperature for 5 hours to be heated and coalescenced, whereby a toner is formed. After completing the operation, the contents of the flask are cooled and sufficiently washed with ion exchanged water, followed by subjecting to solid-liquid separation by Nutsche suction filtration. The solid content is subjected to a washing operation by again dispersing in 3 L of ion exchanged water at 40° C., and then being washed by stirring for 15 minutes. The washing operation is repeated four times, and the solid content is subjected to solid-liquid separation by Nutsche suction filtration, followed by vacuum drying for 12 hours, to obtain a toner of Comparative Example 1.

The resulting toner particles have an accumulated number average particle diameter D₅₀ₙ of 5.7 μm and a number average particle size distribution index GSDn of 1.24, as measured with Coulter counter (TAII, produced by Nikkaki Co., Ltd.). The toner particles are measured for a water content, and it is 0.49%. It is confirmed by observation of the surface state of the toner particles with an electron microscope that the binder resin particles are fused on the surface of the core particles formed with the binder resin, the colorant and the releasing agent, to form a continuous layer. The shape factor SF1 of the toner particles measured with a Luzex image analyzer is 139, and the average shape distribution index (S₈₄/S₁₆)^{1/2} is 1.088.

### Comparative Example 2

The following components are placed in a round-bottom stainless steel flask and sufficiently mixed and dispersed with a homogenizer (Ultra-Turrax T50, produced by IKA Works, Inc.). Thereafter, the contents of the flask are heated on a heating oil bath to 42° C. under agitation, and after maintaining the temperature for 30 minutes, the temperature of the heating oil bath is increased to 45° C., followed by maintaining the temperature for 1 hour, so as to obtain aggregated particles. Subsequently, 25 parts by weight of the binder resin particle dispersion (5) for coating the surface of the aggregated particles thus obtained are further added thereto and gradually agitated.

| | |
|---|---|
| Binder resin particle dispersion (5) | 51.8 parts by weight |
| Colorant dispersion (2) | 28 parts by weight |
| Releasing agent dispersion (2) | 15 parts by weight |
| Polyaluminum chloride | 0.2 part by weight |
| (PAC100W, produced by Asada Chemical Co., | |
| Ltd.) | |

Thereafter, the pH inside the flask is adjusted to a neutral region with a 0.5 M/L sodium hydroxide aqueous solution, and the contents are heated to 95° C. with maintained agitation, followed by maintaining at that temperature for 5 hours to be heated and coalescenced, whereby a toner is formed. After completing the operation, the contents of the flask are cooled and sufficiently washed with ion exchanged water, followed by subjecting to solid-liquid separation by Nutsche suction filtration. The solid content is subjected to a washing operation by again dispersing in 3 L of ion exchanged water at 40° C., and then being washed by stirring for 15 minutes. The washing operation is repeated four times, and the solid content is subjected to solid-liquid separation by Nutsche suction filtration, followed by vacuum drying for 12 hours, to obtain a toner of Comparative Example 2.

The resulting toner particles have an accumulated number average particle diameter D₅₀ₙ of 5.3 μm and a number average particle size distribution index GSDn of 1.23, as measured with Coulter counter (TAII, produced by Nikkaki Co., Ltd.). The toner particles are measured for a water content, and it is 0.55%. It is confirmed by observation of the surface state of the toner particles with an electron microscope that the binder resin particles are fused on the surface of the core particles formed with the binder resin, the colorant and the releasing agent, to form a continuous layer. The shape factor SF1 of the toner particles measured with a Luzex image analyzer is 122, and the average shape distribution index (S₈₄/S₁₆)^{1/2} is 1.091.

(Production of Developer)

A carrier is prepared in the following manner. To a toluene solution formed by dissolving 0.8 part by weight of a polymethyl methacrylate polymer (weight average molecular weight: 120,000) in 10 parts by weight of toluene, 100 parts by weight of Mn—Mg ferrite particles (volume average particle diameter: 40 μm) are added and then subjected to vacuum drying under heating and agitation, so as to obtain a carrier containing the Mn—Mg ferrite particles coated with the polymethyl methacrylate polymer.

8 parts by weight of the toner of Example 1 and 100 parts by weight of the carrier are mixed in a V-blender to obtain a developer of Example 1 (developer 1). Developers of Example 2 (developer 2), Example 3 (developer 3), Example 4 (developer 4), Comparative Example 1 (developer A) and Comparative Example 2 (developer B) are obtained in the same manner as in the production of the developer 1 except that the toners of Examples 2, 3 and 4 and Comparative Examples 1 and 2, respectively, are used instead of the toner of Example 1.

(Test for Forming Image)

A test for forming an image is carried out by using the developers with a test machine obtained by modifying Docu Color 1250 (produced by Fuji Xerox Co., Ltd.) as an image forming apparatus.

The heat roll of the image forming apparatus has an elastic layer using rubber having a rubber hardness of Asker C of 24° and a thickness of 7.5 mm and a surface layer formed with a Teflon (R) tube having a thickness of 20 μm coated on the elastic layer. The pressure roll thereof has a surface that has a rubber hardness of Asker C of 50°. The contact pressure of the heat roll and the pressure roll is set at 55 kgf, and the peripheral velocity of the heat roll is set at 100 mm/sec.

Coated paper having a basis weight of 156 g/m² of an A4 size (210 mm×297 mm) (Mirror-Coat Platinum, produced by Fuji Xerox Office Supply Co., Ltd.) is used as a recording medium. In the test for forming an image, two kinds of coated paper having toner images before fixing treatment each having a size of 5 cm (longitudinal)×4 cm (transversal) formed on the coated paper by using the image forming apparatus are prepared. One kind of the coated paper (hereinafter referred to as “coated paper with toner image A”) has a toner image having a toner holding amount of 0.5 mg/m² per unit area, and the other kind of the coated paper (hereinafter referred to as “coated paper with toner image B”) has a toner image having a toner holding amount of 1.5 mg/m².

(Fixing Characteristics and Evaluation of Image Quality on Test for Forming Image)

A test of oilless fixing is carried out by using the coated paper with toner image B with a modified machine of Docu Color 1250, in which the temperature of the fixing roll can be freely set and monitored, in such a manner that the supply of a releasing oil to the fixing roll is terminated to make a state where no releasing oil is present on the surface of the fixing roll, i.e., oilless fixing. At this time, the surface temperature of the heat roll is changed stepwise, and oilless fixing is carried out by using the coated paper with toner image B at the respective temperatures to form images.

(Measurement of Offset Temperature)

The presence or absence of contamination due to the toner on a blank space of the coated paper is observed to evaluate as to whether or not the toner is transferred to the heat roll to contaminate it. The temperature range in that no contamination occurs is designated as a non-offset temperature region.

(Evaluation of Releasing Property)

Furthermore, upon carrying out the fixing operation within the non-offset temperature range, the state of release of the coated paper and the heat roll in the nip region is observed by viewing to evaluate the releasing property.

(Evaluation of Anti-Blister Property)

The samples after fixing are observed for the extent of occurrence of blister in the image forming part by viewing.

(Evaluation of Glossiness)

Image formation by oilless fixing is carried out by using the coated paper with toner image A at the temperature of the heat roll set at 180° C. The image thus obtained is measured for a glossiness at 75° by using Gloss Meter (produced by Murakami Color Research Laboratories, Inc.).

(Evaluation of OHP Transparency)

A toner image of a toner carrying amount of 0.5 mg/cm² is formed on an OHP sheet of A4 size (size: 210 mm×297 mm, OHP sheet for monochrome printing, produced by Fuji Xerox Office Supply Co., Ltd.) in the same manner as the coated paper with toner image A. Image formation by oilless fixing is carried out by using the OHP sheet at the temperature of the heat roll set at 180° C. to form an image.

The image is measured for a ratio of propagating light to transmitted light to evaluate the OHP transparency. Specifically, a value obtained by converging at an apparent angle of 3.5° is used as the propagating light component of the transmitted light, and the transmitted light ratio (%) is obtained from the proportion to the value obtained by converging at an apparent angle of 45°.

(Measurement of Molecular Weight Distribution of Toner)

The measurement of the molecular weight distribution of the toner is carried out under the following conditions. Molecular weight measuring apparatuses (HLC-8120GPC and SC-8020, produced by Tosoh Corp.) are used, in which columns of TSK gei, Super HM-H (6.0 mm ID×15 cm, two columns) are used, and THF (tetrahydrofuran) is used as an eluent. The measurement conditions are a sample concentration of 0.5%, a flow rate of 0.6 ml/min, a injection amount of the sample of 10 μl and a measuring temperature of 40° C., and a calibration curve is prepared by using 10 standard samples, A-500, F-1, F-10, F-80, F-380, A-2500, F-4, F-40, F-128 and F-700. The data collection interval upon analyzing the samples is 300 ms.

(Evaluation)

The results obtained are shown in Table 1 for the materials of the toner (the binder resin particle dispersion, the colorant dispersion, and the releasing agent dispersion used to prepare Examples and Comparative Examples, the number average molecular weight (Mn) and the molecular weight distribution (Mw/Mn) of the binder resin, the content of the releasing agent in the toner, the melting point of the releasing agent, and the melt viscosity of the releasing agent at 150° C.), the shape of the toner (the shape factor SF1 and the average shape distribution index (S₈₄/S₁₆)^{2/1}), the fixing characteristics (the non-offset temperature region), the image quality characteristics (the glossiness and the OHP transparency), and the evaluation results based on the evaluation standards are shown in Table 2 (the anti-blister property, the glossiness, the releasing property, the anti-offset property and the OHP transparency). The evaluation standards for the anti-blister property, the glossiness, the releasing property, the anti-offset property and the OHP transparency shown in Table 1 are shown in Table 2.

It is understood from Table 1 that the toners obtained in Examples 1 to 4 according to the invention each uses a binder resin having a number average molecular weight (Mn) of from 9,000 to 18,000, a molecular weight distribution represented by a ratio (Mw/Mn) of the weight average molecular weight (Mw) and the number average molecular weight (Mn) of 2.5 or less, and a narrow shape distribution, and thus even when an image is formed on coated paper, favorable results are obtained, i.e., it is high in glossiness and is good in OHP transparency, releasing property, anti-offset property and anti-blister property. Offset can be suppressed to a level that is practically sufficient even at a high temperature region owing to the releasing agent content of 10% by weight or more.

With respect to the anti-blister property, in particular, occurrence of blister is completely prevented in these samples, and results that practically cause no problem are obtained for the other factors, while there are cases that some characteristics are slightly lowered. Therefore, all the characteristics are satisfied.

On the other hand, the toner of Comparative Example 1 uses a binder resin having a number average molecular weight (Mn) of 9,800, which is in the range of from 9,000 to 18,000 defined by the invention, but the molecular weight distribution represented by Mw/Mn is as large as 3.0. Therefore, the glossiness is somewhat lowered due to the increase of the high molecular weight component of the resin molecular constituting the binder resin, and occurrence of blister cannot be completely prevented, but some blister occurs, particularly, upon high temperature fixing. Furthermore, the releasing property is considerably poor, which practically causes problems, due to the influence of the low molecular weight components and the added amount of the releasing agent. The glossiness and the OHP transparency are slightly lowered.

The toner of Comparative Example 2 uses a binder resin having a number average molecular weight (Mn) of 7,500, which is lower than 9,000 as the lower limit defined by the invention, and the molecular weight distribution represented by Mw/Mn is as large as 5.3. Therefore, a toner having a narrow shape distribution cannot be obtained, and all the characteristics are very poor except that the anti-offset property is excellent upon high temperature fixing. The toner is in such a level that cannot be practically utilized.

TABLE 1
(Evaluation Results)

| Characteristics and evaluation results of toners | | | Ex 1 | Ex 2 | Ex 3 | Ex 4 | CE 1 | CE 2 |
|---|---|---|---|---|---|---|---|---|
| Toner | Binder | Binder resin particle dispersion | 1 | 2 | 2 | 3 | 4 | 5 |
| materials | resin | Number average molecular weight | 13.0 | 11.0 | 11.0 | 12.0 | 9.8 | 7.5 |
| | | (Mw) | | | | | | |
| | | Molecular weight distribution | 2.2 | 2.0 | 2.0 | 1.9 | 3.0 | 5.3 |
| | | (Mw/Mn(k)) | | | | | | |
| | Colorant | Colorant dispersion | 1 | 1 | 1 | 1 | 1 | 2 |
| | Releasing | Releasing agent dispersion | 2 | 1 | 1 | 2 | 1 | 2 |
| | agent | Content of releasing agent | 12 | 7 | 15 | 12 | 7 | 15 |
| | | (% by weight) | | | | | | |
| | | Melting point of releasing agent (° C.) | 100 | 85 | 85 | 100 | 85 | 100 |
| | | Melt viscosity at 150° C. (cp) | 12 | 10 | 10 | 12 | 10 | 12 |

| | | | | | | | |
|---|---|---|---|---|---|---|---|
| Toner shape | Shape factor SF1 | 125 | 131 | 132 | 126 | 139 | 118 |
| | Average shape distribution index | 1.074 | 1.073 | 1.076 | 1.071 | 1.088 | 1.091 |
| | (S₈₄/S₁₆)^{1/2} | | | | | | |
| Fixing property | Non-offset temperature region (° C.) | 130-190 | 130-175 | 125-200 | 125-190 | 135-205 | 155-220 |
| Image quality | Glossiness (75° C.) | 81 | 87 | 76 | 82 | 60 | 44 |
| | OHP transparency (%) | 79 | 86 | 76 | 84 | 72 | 52 |
| Evaluation results | Anti-blister property | A | A | A | A | B | C |
| (based on standard | Glossiness property | A | A | A | A | B | C |
| shown in Table 2) | Releasing property | A | B | A | A | C | C |
| | Anti-offset property | A | B | A | A | A | A |
| | OHP transparency | B | A | B | A | B | C |

TABLE 2
(Evaluation Standards)

| | Determination method | Evaluation standard | | |
|---|---|---|---|---|
| Evaluation Item | for evaluation standard | A | B | C |
| Anti-blister | Image defect | no occurrence | slight occurrence | considerable |
| property | | | | occurrence |
| Glossiness | Value of glossiness | 70 or more | less than 70 and more | 45 or less |
| | | | than 45 | |
| Releasing property | Winding on roll upon | no occurrence of | occurrence of winding | considerable |
| | fixing | winding | but releasable | occurrence of winding |
| Anti-offset | Upper limit of anti-offset | 180° C. or more | less than 180° C. and | 170° C. or less |
| property | temperature | | more than 170° C. | |
| OHP transparency | Ratio of transmitted light | 80% or more | less than 80% and more | 70% or less |
| | (OHP transparency) (%) | | than 70% | |

As described in the foregoing, according to the invention, such a toner for developing an electrostatic latent image can be provided that can prevent occurrence of blister even with coated paper having a coated surface, exhibits excellent releasing performance in oilless fixing, and realizes both high glossiness and OHP transparency for an image to be formed. The invention also can provide a process for producing the toner for developing an electrostatic latent image, a developer containing the toner for developing an electrostatic latent image, and a process for forming an image using the toner for developing an electrostatic latent image.

The entire disclosure of Japanese Patent Application No. 2002-36801 filed on Feb. 14, 2002 including specification, claims and abstract is incorporated herein by reference in its entirety.

What is claimed is:

1. A toner for developing an electrostatic latent image comprising a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

2. The toner for developing an electrostatic latent image as claimed in claim 1, wherein the releasing agent has a melting point in a range of from 70 to 120° C. and a melt viscosity at 150° C. in a range of from 1 to 150 centipoise.

3. The toner for developing an electrostatic latent image as claimed in claim 1, wherein a content of the releasing agent contained in the toner for developing an electrostatic latent image is 10% by weight or more.

4. The toner for developing an electrostatic latent image as claimed in claim 1, wherein the toner has a shape factor SF1 represented by the following equation (1) of 140 or less:
SF1=R²/A×π/4×100 (1)
wherein R represents a maximum length of the toner, and A represents a projected area of the toner.

5. The toner for developing an electrostatic latent image as claimed in claim 1, wherein the toner has an average shape distribution index (S₈₄/S₁₆)^{1/2} of the toner particles of 1.08 or less.

6. The toner for developing an electrostatic latent image as claimed in claim 1, wherein a content of the releasing agent contained in the toner is 25% by weight or less.

7. The toner for developing an electrostatic latent image as claimed in claim 1, wherein the releasing agent has an endothermic peak at a temperature in a range of from 50 to 140° C.

8. The toner for developing an electrostatic latent image as claimed in claim 1, wherein the releasing agent has a melting point in a range of from 70 to 105° C. and a melt viscosity at 150° C. in a range of from 2 to 100 centipoise.

9. The toner for developing an electrostatic latent image as claimed in claim 1, wherein the toner is produced by a wet process comprising steps of: aggregating a particles in a dispersion containing binder resin particles, colorant particles and releasing agent particles, to obtain aggregated particles; and heating the aggregated particles to coalesce them.

10. A developer for developing an electrostatic latent image comprising a toner and a carrier, the toner comprising a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

11. The developer for developing an electrostatic latent image as claimed in claim 10, wherein the carrier has a resin coating layer.

12. The developer for developing an electrostatic latent image as claimed in claim 10, wherein the toner has a shape factor SF1 represented by the following equation (1) of 140 or less:
SF1=R²/A×π4×100 (1)
wherein R represents a maximum length of the toner, and A represents a projected area of the toner.

13. The developer for developing an electrostatic latent image as claimed in claim 10, wherein a content of the releasing agent contained in the toner is 10% by weight or more based on the total solid content constituting the toner.

14. A process for producing a toner for developing an electrostatic latent image, the process comprising a first step of:
aggregating particles in a dispersion containing binder resin particles, colorant particles and releasing agent particles, to obtain aggregated particles; and
heating the aggregated particles to coalesce them,
the toner comprising a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

15. The process for producing a toner for developing an electrostatic latent image as claimed in claim 14, wherein the binder resin particles have a center diameter (median diameter) of 1 μm or less.

16. The process for producing a toner for developing an electrostatic latent image as claimed in claim 14, wherein the binder resin particles are produced by emulsion polymerization comprising a step of polymerizing by supplying a monomer and a chain transfer agent to a reaction solution containing an initiator, and the monomer and the chain transfer agent are supplied to the reaction solution, whereby a concentration of the chain transfer agent with respect to the monomer is maintained at a constant value during supplying.

17. The process for producing a toner for developing an electrostatic latent image as claimed in claim 14, wherein the binder resin particles are produced by emulsion polymerization comprising a step of polymerizing by supplying a monomer and a chain transfer agent to a reaction solution containing an initiator, and the monomer and the chain transfer agent are supplied to the reaction solution, whereby a concentration of the chain transfer agent with respect to the monomer is decreased during supplying.

18. A process for forming an image comprising the steps of: forming an electrostatic latent image on an electrostatic latent image holding member; developing the electrostatic latent image with a developer containing a toner to form a toner image; transferring the toner image to a transfer material; and fixing with heat the toner image thus transferred to the transfer member to a recording medium,
the toner comprising a binder resin, a releasing agent and a colorant, the binder resin having a number average molecular weight (Mn) in a range of from 9,000 to 18,000 and a molecular weight distribution represented by a ratio (Mw/Mn) of a weight average molecular weight (Mw) and a number average molecular weight (Mn) of 2.5 or less, and the binder resin containing a vinyl resin.

19. The process for forming an image as claimed in claim 18, wherein the toner has a shape factor SF1 represented by the following equation (1) of 140 or less:
SF1=R²/A×π/4×100 (1)
wherein R represents a maximum length of the toner, and A represents a projected area of the toner.

20. The process for forming an image as claimed in claim 18, wherein the recording medium is coated paper.
